(19) United States
(12) Patent Application Publication
(10) Pub. No.: US 2025/0383460 A1
(43) Pub. Date: Dec. 18, 2025

(54) Ion Chamber Architecture for High-Speed Positional Readout

(71) Applicant: Pyramid Technical Consultants Inc., Waltham, MA (US)

(72) Inventor: Raymond Paul Boisseau, Waltham, MA (US)

(21) Appl. No.: 19/239,169

(22) Filed: Jun. 16, 2025

Related U.S. Application Data
(60) Provisional application No. 63/659,905, filed on Jun. 14, 2024.

(51) Int. Cl. G01T 1/29

(52) U.S. Cl. CPC G01T 1/2928

(57) ABSTRACT

A position detector for a charged particle beam comprises high-voltage planes, a first single-axis detector, and a second single-axis detector. The first single-axis detector includes a first electrode set having first shapes in a first orientation, spatially distributed with respect to a first axis, and electrically connected to one another; and a second electrode set having the first shapes in a second orientation, spatially distributed with respect to the first axis, interleaved with the first electrode set, and electrically connected to one another. The second single-axis detector includes a third electrode set having second shapes in a third orientation, spatially distributed with respect to a second axis, and electrically connected to one another; and a fourth electrode set having the second shapes in a fourth orientation, spatially distributed with respect to the second axis, interleaved with the third electrode set, and electrically connected to one another.

### CROSS-REFERENCE TO RELATED APPLICATIONS

This application claims priority to U.S. Provisional Application No. 63/659,905, titled “Ion Chamber Architecture For High-Speed Positional Readout,” filed on Jun. 14, 2024, which is hereby incorporated by reference.

### TECHNICAL FIELD

This application relates generally to position detectors for charged particle beams.

### BACKGROUND

Research in the field of radiation therapy indicates that healthy tissue is spared if the therapeutic dose is delivered in a very short time. This approach, referred to as “FLASH” irradiation, requires instrumentation that can measure process parameters and respond in much shorter times than with conventional therapy. One critical process parameter is the ion beam position as it enters the patient. This is typically done using projection strip detectors, which can localize beam centroids with good accuracy. These may use 32, 64, 128 or more discrete strips per axis to get sufficient positional accuracy. The data from this set of strips is digitized and then sent to a microprocessor that determines the centroid. Affordable high-channel density electronics that support such systems are relatively slow, so that they are limited to data rates in the few kHz range. FLASH requires data rates of 100-1000 kHz. There is therefore a need for a new approach to the problem of centroid determination.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An embodiment is directed to a position detector for a charged particle beam, comprising a first high-voltage plane; a first single-axis detector disposed in a first detector plane comprising a first electrode having a set of first electrode elements, each first electrode element having a first shape in a first orientation, the first electrode elements spatially distributed with respect to a first axis, the first electrode elements electrically connected to one another; and a second electrode having a set of second electrode elements, each second electrode element having the first shape in a second orientation that is different than the first orientation, the second electrode elements spatially distributed with respect to the first axis and interleaved with the first electrode elements, the second electrode elements electrically connected to one another; a second high-voltage plane, the first single-axis detector disposed between the first and second high-voltage planes; a second single-axis detector in a second detector plane comprising a third electrode having a set of third electrode elements, each third electrode element having a second shape in a third orientation, the third electrode elements spatially distributed with respect to a second axis, the third electrode elements electrically connected to one another; and a fourth electrode having a set of fourth electrode elements, each fourth electrode element having the second shape in a fourth orientation that is different than the third orientation, the fourth electrode elements spatially distributed with respect to the second axis and interleaved with the third electrode elements, the fourth electrodes electrically connected to one another; and a third high-voltage plane, the second single-axis detector disposed between the second and third high-voltage planes, wherein the first detector plane, the second detector plane, the first high-voltage plane, the second high-voltage plane, and the third high-voltage plane are substantially parallel to one another.

An embodiment is directed to a position detector system for a charged particle beam, comprising a first high-voltage plane; a first single-axis detector disposed in a first detector plane comprising a set of first electrodes, each first electrode having a first shape in a first orientation, the first electrodes spatially distributed with respect to a first axis, the first electrodes electrically connected to one another; and a set of second electrodes, each second electrode having the first shape in a second orientation that is different than the first orientation, the second electrodes spatially distributed with respect to the first axis and interleaved with the first electrodes, the second electrodes electrically connected to one another; a second high-voltage plane, the first single-axis detector disposed between the first and second high-voltage planes; a second single-axis detector in a second detector plane comprising a set of third electrodes, each third electrode having a second shape in a third orientation, the third electrodes spatially distributed with respect to a second axis, the third electrodes electrically connected to one another; and a set of fourth electrodes, each fourth electrode having the second shape in a fourth orientation that is different than the third orientation, the fourth electrodes spatially distributed with respect to the second axis and interleaved with the third electrodes, the fourth electrodes electrically connected to one another; and a third high-voltage plane, the second single-axis detector disposed between the second and third high-voltage planes; a readout circuit comprising a first current-voltage amplifier having an input electrically coupled to an output of the set of first electrodes; a second current-voltage amplifier having an input electrically coupled to an output of the set of second electrodes; a third current-voltage amplifier having an input electrically coupled to an output of the set of third electrodes; a fourth current-voltage amplifier having an input electrically coupled to an output of the set of fourth electrodes; and an analog-to-digital converter (ADC) having a respective input electrically coupled to a respective output of each current-voltage amplifier; and a microprocessor having an input electrically coupled to an output of the ADC.

An embodiment is directed to a position detector system for a charged particle beam, comprising a first high-voltage plane; a first single-axis detector disposed in a first detector plane comprising a set of first electrodes, each first electrode having a first shape in a first orientation, the first electrodes spatially distributed with respect to a first axis, the first electrodes electrically connected in parallel; and a set of second electrodes, each second electrode having the first shape in a second orientation that is different than the first orientation, the second electrodes spatially distributed with respect to the first axis and interleaved with the first electrodes, the second electrodes electrically connected in parallel; a second high-voltage plane, the first single-axis detector disposed between the first and second high-voltage planes; a second single-axis detector in a second detector plane comprising a set of third electrodes, each third electrode having a second shape in a third orientation, the third electrodes spatially distributed with respect to a second axis, the third electrodes electrically connected in parallel; and a set of fourth electrodes, each fourth electrode having the second shape in a fourth orientation that is different than the third orientation, the fourth electrodes spatially distributed with respect to the second axis and interleaved with the third electrodes, the fourth electrodes electrically connected in parallel; and a third high-voltage plane, the second single-axis detector disposed between the second and third high-voltage planes; and a readout circuit comprising a first current-voltage amplifier having an input electrically coupled to an output of the set of first electrodes, the first current-voltage amplifier producing, at a first output, a first voltage corresponding to a first current from the set of first electrodes; a second current-voltage amplifier having an input electrically coupled to an output of the set of second electrodes, the second current-voltage amplifier producing, at a second output, a second voltage corresponding to a second current from the set of second electrodes; a third current-voltage amplifier having an input electrically coupled to an output of the set of third electrodes, the third current-voltage amplifier producing, at a third output, a third voltage corresponding to a third current from the set of third electrodes; a fourth current-voltage amplifier having an input electrically coupled to an output of the set of fourth electrodes, the fourth current-voltage amplifier producing, at a fourth output, a fourth voltage corresponding to a fourth current from the set of fourth electrodes; a first analog circuit having a first input electrically coupled to the first output of the first current-voltage amplifier and a second input electrically coupled to the second output of the second current-voltage amplifier, the first analog circuit configured to produce a fifth voltage corresponding to a ratio of a difference of the first and second voltages with respect to a sum of the first and second voltages; a second analog circuit having a third input electrically coupled to the third output of the third current-voltage amplifier and a fourth input electrically coupled to the fourth output of the fourth current-voltage amplifier, the second analog circuit configured to produce a sixth voltage corresponding to a ratio of a difference of the third and fourth voltages with respect to a sum of the third and fourth voltages; an analog-to-digital converter (ADC) having a first input electrically coupled to a first output of the first analog circuit and a second input electrically coupled to a second output of the second analog circuit, the ADC configured to convert the fifth and sixth voltages into fifth and sixth digital voltage values, respectively; and a microprocessor having an input electrically coupled to an output of the ADC, the microprocessor configured to determine a first position of the charged particle beam relative to the first axis using the fifth digital voltage value and to determine a second position of the charged particle beam relative to the second axis using the sixth digital voltage value.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is a block diagram of a ion beam therapy system according to one or more embodiments.

FIG. 2 is an exploded view of the ion chamber shown in FIG. 1 according to one or more embodiments.

FIG. 3 is front view of the first single-axis detector shown in FIG. 2 according to one or more embodiments.

FIG. 4 is an example cross section of the first single-axis detector shown in FIG. 3.

FIG. 5 is front view of the second single-axis detector shown in FIG. 2 according to one or more embodiments.

FIG. 6 is a block diagram of readout circuitry for the first and second single-axis detectors according to one or more embodiments.

FIG. 7 is a block diagram of readout circuitry for the first and second single-axis detectors according to one or more alternative embodiments.

### DETAILED DESCRIPTION

A position detector provides rapid readout of the centroid position of directed beams of ionizing radiation. A fast, simple, and robust electronic chain is made possible through the use of only two pairs of electrode sets, generating a single pair of signals that can be evaluated quickly though direct analog or digital means. This feature allows very rapid data processing as compared to systems using multiple independent electrodes. The simplicity of the detector also allows the beam position (e.g., centroid values) to be determined using analog circuitry, bypassing digital and processor systems in certain time and safety-sensitive applications. This simplicity allows safety circuitry to detect “out-of-bounds” conditions in a safe and rapid way.

The position detector includes a first single-axis detector and a second single axis-detector. The first single-axis detector includes a first electrode set of first electrodes and a second electrode set of second electrodes. The first and second electrodes have a first shape. In the first electrodes, the first shape is in a first orientation. In the second electrodes, the first shape is in a second orientation that is different than the first orientation. The first and second electrodes are spatially distributed and interleaved (e.g., in an alternating arrangement) with respect to the first axis. The first and second orientations of the first shape provide a complementary pattern and/or structure. The first electrode set has an approximately linear relationship in the surface area of the first shapes relative to a position in a first direction, relative to a second axis that is orthogonal to the first axis. The second electrode set has an approximately linear relationship in the surface area of the first shapes relative to a position in a second direction, opposite to the first direction, relative to the second axis.

The second single-axis detector includes a third electrode set of third electrodes and a fourth electrode set of fourth electrodes. The third and fourth electrodes have a second shape. In the third electrodes, the second shape is in a third orientation. In the fourth electrodes, the second shape is in a fourth orientation that is different than the third orientation. The third and fourth electrodes are spatially distributed and interleaved (e.g., in an alternating arrangement) with respect to the second axis. The third and fourth orientations of the second shape provide a complementary pattern and/or structure. The third electrode set has an approximately linear relationship in the surface area of the second shapes relative to a position in a third direction, relative to the first axis. The second electrode set has an approximately linear relationship in the surface area of the second shapes relative to a position in a fourth direction, opposite to the third direction, relative to the first axis.

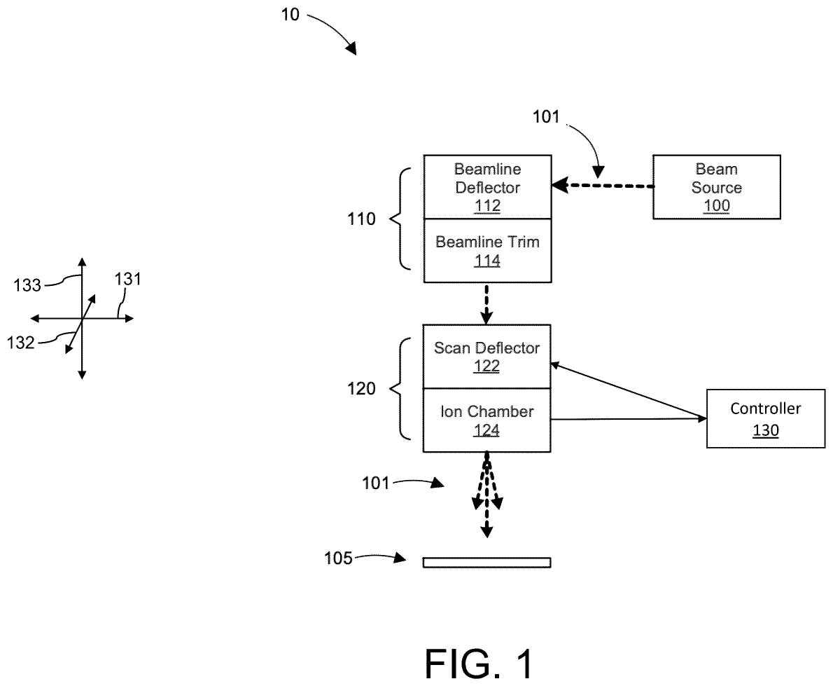

FIG. 1 is a block diagram of a ion beam therapy system 10 according to one or more embodiments. The ion beam therapy system 10 can be a pencil beam proton therapy system (PBS). The system 10 includes an ion beam source 100, which can produce an ionized radiation beam 101 at a desired or target energy level, such as 30 MeV to 250 MeV. The beam 101 passes through a beam transport beamline 110 and a scanning system and dose measurement system 120 (sometimes referred to as a scan nozzle).

The beam transport beamline 110 deflects the beam 101 as needed using one or more primary bending electromagnets 112, fine trim electromagnets 114, and/or other components. One or more scan deflector electromagnets 122 deflect(s) the beam 101 to a target location or “spot” in a patient. The primary bending electromagnets 112, fine trim electromagnets 114, and/or scan deflector electromagnets 122 can comprise quadrupole electromagnets, sextupole electromagnets, and/or electrostatic deflectors.

An ion chamber 124 is located between the scan deflector 122 and the target of the beam 101. The ion chamber 124 can alternately be referred to as a beam position detector. During therapy, the target is at a location or “spot” in a patient, but the target is characterized for control purposes by its projection onto a nominal isocenter plane 105, which can alternatively be referred to as the target. The spots are defined in the treatment planning system (e.g., in irradiation maps) as having x and y positions (e.g., in mm) relative to first and second axes 131, 132, respectively, a beam energy (e.g., in MeV), a spot size in each of the first and second axes 131, 132 (e.g., defined as a sigma of a Gaussian-shaped beam along each axis) and a target/required dose. Prior to passing through the scan deflector electromagnets 122, the beam 101 travels parallel to a third axis 133. The axes 131-133 are mutually orthogonal.

During treatment (and calibration), a controller 130 receives output signals from the ion chamber 124 to determine the two-dimensional position (e.g., with respect to the first and second axes 131, 132) of the beam 101, at the location of the ion chamber 124. The controller 130 can determine the two-dimensional position based on the beam centroid, which the controller 130 can determine using the output signals from the ion chamber 124. The controller 130 can compare the measured beam centroid with a target beam centroid and can adjust the control signals sent to the scan deflector electromagnets 122 to reduce any difference or variance between the measured and target beam centroids.

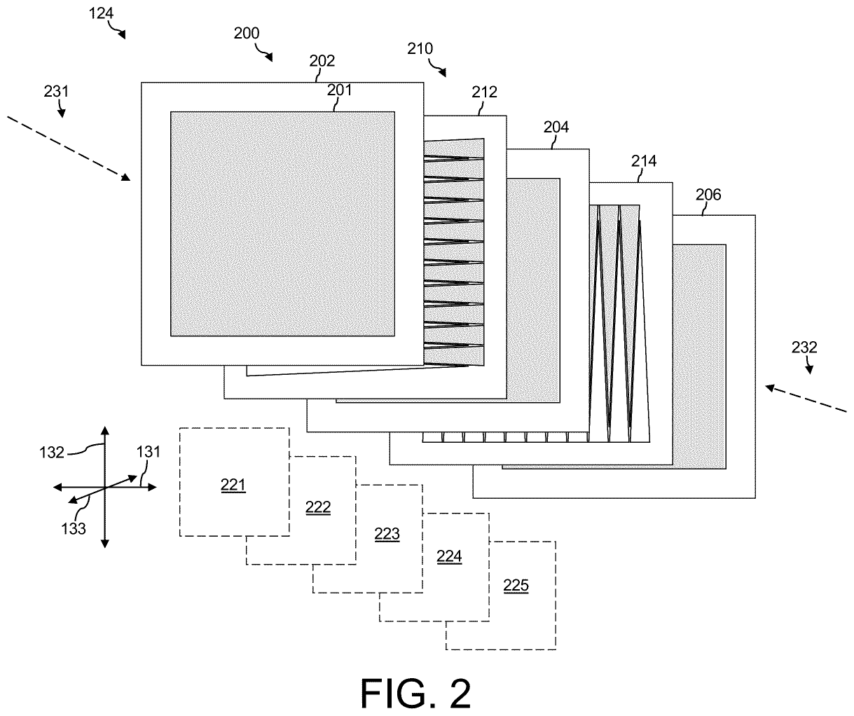

FIG. 2 is an exploded view of the ion chamber 124 according to one or more embodiments. The ion chamber 124 includes an alternating arrangement of high-voltage planes 200 and axial position detectors 210. The axial position detector 210 includes a first single-axis detector 212 and a second single-axis detector 214. The first single-axis detector 212 is disposed between a first high-voltage plane 202 and a second high-voltage plane 204. The second single-axis detector 214 is disposed between the second high-voltage plane 204 and a third high-voltage plane 206. The high-voltage planes 200 include respective electrodes 201 that produce electric fields that are used to operate the ion chamber 124. The high-voltage planes 200 and the axial position detectors 210 are disposed in and/or supported by a housing or frame.

The high-voltage planes 200 and axial position detectors 210 are in respective planes that are parallel to a plane defined by the first and second axes 131, 132. For example, the first high-voltage plane 202 is disposed in or parallel to a first plane 221. The first single-axis detector 212 is disposed in or parallel to a second plane 222. The second high-voltage plane 204 is disposed in or parallel to a third plane 223. The second single-axis detector 214 is disposed in or parallel to a fourth plane 224. The third high-voltage plane 206 is disposed in or parallel to a fifth plane 225. Each plane 221-225 is parallel to one another and to a plane defined by the first and second axes 131, 132.

The ion chamber 124 can be configured and/or oriented such that an ionizing beam 231 passes through the first high-voltage plane 202 before passing through the other components (e.g., the first single-axis detector 212, the second high-voltage plane 204, and so on). Alternatively, the ion chamber 124 can be configured such that an ionizing beam 232 passes through the third high-voltage plane 206 before passing through the other components (e.g., the second single-axis detector 214, the second high-voltage plane 204, and so on). The beam 231, 232 can be the same as the beam 101 (FIG. 1).

As the ionizing beam 231 or 232 passes through the gas layers between and perpendicular to the electrodes, it creates a charge cloud of equal and opposite charges with a spatial distribution proportional to the beam current intensity. It is this charge cloud that is collected by the electrodes.

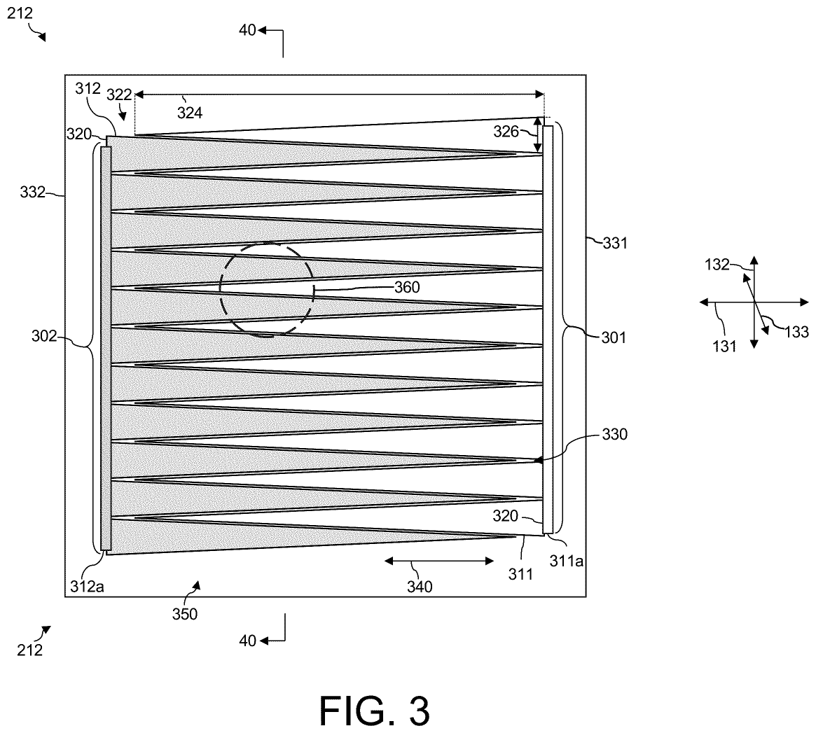

FIG. 3 is front view of the first single-axis detector 212 according to one or more embodiments. The first single-axis detector 212 includes two interleaved electrode sets 301, 302 that are shaped and/or configured to provide an approximately linear relationship between centroid position and the difference in area of the electrode sets 301, 302. A back view of the single-axis detector 212 is the same as the front view.

The first electrode set 301 includes a plurality of first electrode elements 311 that are spatially distributed along and/or relative to the second axis 132. The first electrodes 311 have the same shape (e.g., a first shape) as one another. In the illustrated embodiment, the first shape is a triangle (e.g., a first triangle). The bases 320 of the triangles that form the first electrodes 311 are spatially aligned with each other (e.g., relative to the first axis 131) and are parallel to the first axis 131. In addition, the bases 320 of the triangles that form the first electrodes 311 are located closer to a first side 331 of the first single-axis detector 212, as measured relative to the first axis 131, than to an opposing second side 332 of the first single-axis detector 212. The first and second sides 331, 332 can be parallel to the second axis 132. Additionally or alternatively, an axis 340 that is parallel to the first axis 131 can extend between the first and second sides 331, 332. The axis 340 can orthogonally intersect the first and second sides 331, 332. The first and second sides 331, 332 can also be first and second sides of the ion chamber 124.

The second electrode set 302 includes a plurality of second electrode elements 312 that are spatially distributed along and/or relative to the second axis 132. The second electrodes 312 have the same shape (e.g., the first shape) as one another and the same shape as the first electrodes 311. The bases 320 of the triangles that form the second electrodes 312 are spatially aligned with each other (e.g., relative to the first axis 131) and are parallel to the second axis 132. The bases 320 of the triangles that form the second electrodes 312 are parallel to the bases 320 of the triangles that form the first electrodes 311. In addition, the bases 320 of the triangles that form the second electrodes 312 are located closer to the second side 332 of the first single-axis detector 212 than to the first side 331 of the first single-axis detector 212.

In this example, we may refer to the elongated electrode elements (shown as triangular in shape) as electrodes, but unless stated otherwise, such electrodes and electrode elements shall be considered similarly for the present purpose. In a preferred embodiment, the present electrodes 311, 312 have such elongated shapes that are interleaved over a common surface yet are electrically isolated from one another. Specifically, the elongated electrode elements of each electrode may be referred to as electrode elements. Said electrode elements may be electrically coupled to one another at one end thereof using electrically conducting bus bars 311a, 312a or suitable connection points.

The first electrodes 311 are in the same orientation (e.g., a first orientation) as one another. The second electrodes 312 are in the same orientation (e.g., a second orientation) as one another but in a different orientation than the first electrodes 311. The orientation of the first electrodes 311 is the opposite of the orientation of the second electrodes 312. For example, the orientation of each first electrode 311 (e.g., triangle) in the first electrode set 301 is offset by 180 degrees relative to the orientation of each second electrode 312 (e.g., triangle) in the second electrode set 302. Offsetting the orientation of the first and second electrodes 311, 312 by 180 degrees creates complementary shapes/orientations that allow the first and second electrodes 311, 312 to be nested and/or interleaved with each other to maximize signal-detection area.

The electrode elements may be triangular in shape, and may be interleaved as shown, forming the first and second electrodes 311, 312. The electrode elements may have an elongated height 324 relative to a length 326 of the base 320 (i.e., the height 324 can be larger than the length 326). The height 324 can be measured from the base 320 to an apex 322 of the triangle along or relative to the first axis 131 and/or along or relative to the axis 340. The length of the base 320 can be measured along or relative to the second axis 132. In one or more embodiments, the height 324 can be 20 to 200 times the length 326 of the base 320.

The first electrodes 311 are electrically connected to one another, e.g., connected in parallel with each other, but are not electrically connected to (e.g. electrically isolated from) the second electrodes 312. The second electrodes 312 are electrically connected to one another, e.g., connected in parallel with each other, and are not electrically connected to (e.g. electrically isolated from) the first electrodes 311. A gap 330 is defined between and surrounds each first electrode 311 and each second electrode 311 so as to prevent electrical shorting between neighboring first electrodes 311, between neighboring second electrodes 312, and between neighboring first and second electrodes 311, 312. The first electrodes 311 and/or the second electrodes 312 can be different shapes and/or can have different orientations in other embodiments, such as complementary shapes that can be nested and/or interleaved with each other to maximize signal-detection area. Therefore, the first electrodes 311 may comprise a plurality of electrically extended portions that are physically and/or electrically separated from second electrodes 312 by a gap or electrical isolation space 330. Each of the first electrode elements 311 may be electrically and/or mechanically coupled to a common connecting bus or bar 311a; and each of the second electrode elements 312 may be electrically and/or mechanically coupled to a second common connecting bus or bar 312a. The electrode connecting buses or bars 311a, 312a may be internal or external with respect to the electrode geometry and design.

The first and second electrodes 311, 312 are interleaved and/or nested to cover the entire sensor plane 350, which is shown as square in FIG. 3. The sensor plane 350 can be another shape, such as rectangular, in other embodiments.

The first and second electrodes 311, 312 are configured and/or arranged such that the difference in the area of the first and second electrodes 311, 312 is linear or approximately linear (e.g., within about 5%) relative to and/or along the first axis 131. For example, the first electrodes 311 decrease in area linearly or approximately linearly relative to the first axis 131 in a first direction (e.g., from the base 320 to the apex 322 of each first electrode 311). The second electrodes 312 decrease in area linearly or approximately linearly relative to the first axis 131 in a second direction (e.g., from the base 320 to the apex 322 of each second electrode 312), opposite to the first direction.

An ionizing beam 360 passing through the first single-axis detector 212 in the perpendicular direction (e.g., parallel or substantially parallel to the third axis 133) will generate charge along its trajectory. This charge will be driven by the electric field to the first single-axis detector 212. The proportion of charge sensed by the first single-axis detector 212 is proportional to the intersection of the charge cloud and the first and second electrodes sets 301, 302. Since the relative areas of the first and second electrodes 311, 312 in the first and second electrodes sets 301, 302, respectively, is linear (or approximately linear) in position relative to the first axis 131, the ratio of the two charge values yields the position of the beam centroid relative to the first axis 131.

The first single-axis detector 212 can be optimized to reduce the capacitance of the detectors, which improves the signal-to-noise ratio, and therefore the accuracy of the measurement. For example, measurements of current in the nA to μA regime typically utilize the “transimpedance” amplifier topology. A source of current noise in such circuits is due to the input noise voltage of the amplifier driving current into the detector impedance. Since the impedance of the detector is inversely proportional to the capacitance of the detector, every effort should be made to minimize the detector capacitance.

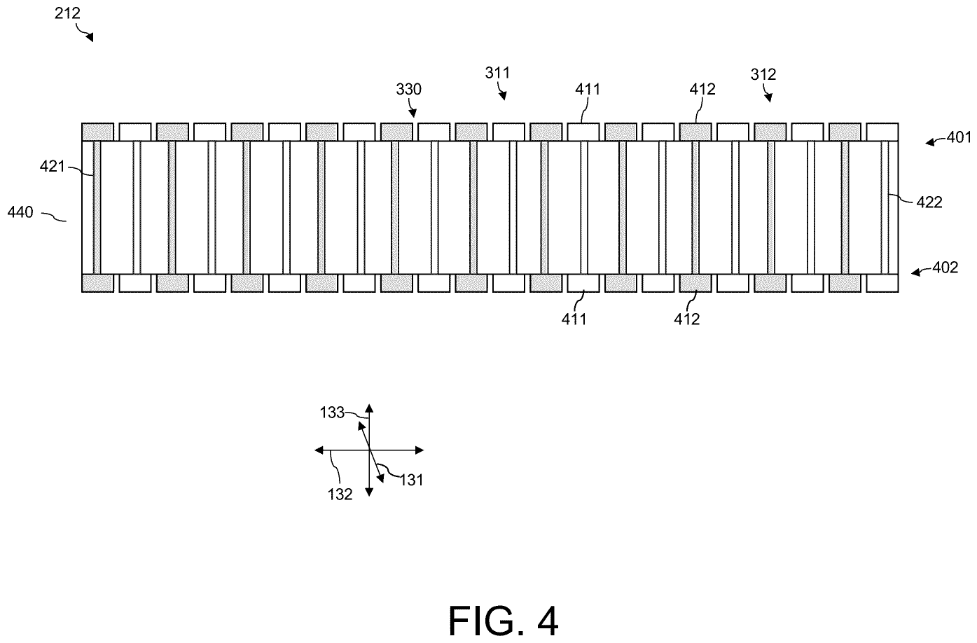

The first and second electrodes 311, 312 can comprise a thin-film, radiation-resistant substrate coated with one or more thin metal layers to form the electrodes 301, 302. In an exemplary aspect, the electrodes 311, 312 are formed as structured metal films on an insulating plastic or similar substrate. Additionally, a layer of gold may be applied or formed on the layers of metal to prevent oxidation. To avoid the high capacitance arising from independent electrodes 311, 312 coupling through thin film, the electrode pattern can be duplicated on both sides of the substrate, and the matching pairs connected electrically using plated through holes and/or external connection means. This effectively creates a single electrode structure with minimal capacitance to surrounding electrodes. An example cross section through plane 40 is shown in FIG. 4. The cross section shows that each first electrode 311 includes one or more patterned first metal layers 411 on a first side 401 of a substrate 440 and one or more patterned first metal layers 411 on a second side 402 of the substrate 440. The metal layer(s) 411 on the first and second sides 401, 402 of the substrate 440 in a respective first electrode 311 are electrically connected through a conductive metal via 421. Likewise, each second electrode 312 includes one or more patterned second metal layers 412 on the first side 401 of the substrate 440 and one or more patterned second metal layers 412 on the second side 402 of the substrate 440. The metal layer(s) 412 on the first and second sides 401, 402 of the substrate 440 in a respective second electrode 312 are electrically connected through a conductive metal via 422.

The capacitance between the first and second electrodes 311, 312 is significant but can be reduced by increasing the un-plated kerf width (e.g., gaps 330) between the first and second electrodes 311, 312. This should be balanced against the impact on position accuracy. The larger the gaps 330, the greater reduction in capacitance between the first and second electrodes 311, 312 but the greater reduction/impact on position accuracy.

Additionally or alternatively, the capacitance between the first and second electrodes 311, 312 can be reduced by increasing the pitch of the pattern. This should be balanced against the impact on position accuracy due to poor sampling of the beam diameter.

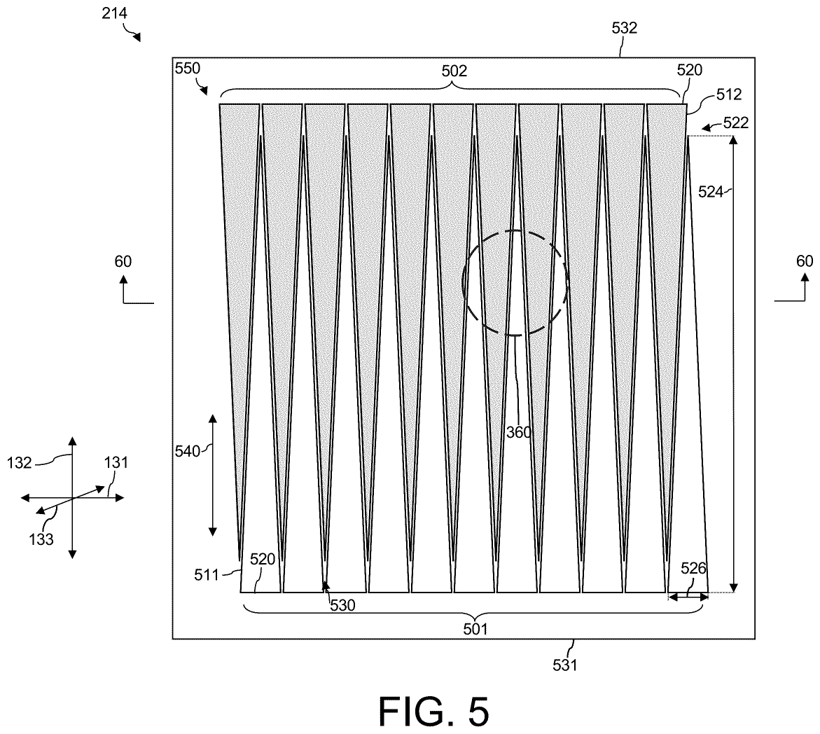

FIG. 5 is front view of the second single-axis detector 214 according to one or more embodiments. The second single-axis detector 214 includes two interleaved electrode sets 501, 502 that are that are shaped and/or configured to provide an approximately linear relationship between centroid position and the difference in area of the electrode sets 501, 502. A back view of the single-axis detector 214 is the same as the front view.

The second single-axis detector 214 can be identical to the first single-axis detector 212 but the second single-axis detector 214 is rotated by 90 degrees relative to the first single-axis detector 212 (or alternatively, the first single-axis detector 212 is rotated by 90 degrees relative to the second single-axis detector 214).

The first electrode set 501 includes a plurality of first electrodes 511 that are spatially distributed along and/or relative to the first axis 131. The first electrodes 511 have the same shape (e.g., a second shape) as one another. In the illustrated embodiment, the second shape is a triangle (e.g., a second triangle), which can be the same as the first triangle (the shape of the first and second electrodes 311, 312 (FIG. 3)). The bases 520 of the triangles that form the first electrodes 511 are spatially aligned with each other (e.g., relative to the second axis 132) and are parallel to the first axis 131. In addition, the bases 520 of the triangles that form the first electrodes 511 are located closer to a first side 531 of the second single-axis detector 214, as measured relative to the second axis 132, than to an opposing second side 532 of the second single-axis detector 214. The first and second sides 531, 532 can be parallel to the first axis 131. Additionally or alternatively, an axis 540 that is parallel to the second axis 132 can extend between the first and second sides 531, 532. The axis 540 can orthogonally intersect the first and second sides 531, 532. The first and second sides 531, 532 can also be third and fourth sides of the ion chamber 124.

The second electrode set 502 includes a plurality of second electrodes 512 that are spatially distributed along and/or relative to the first axis 131. The second electrodes 512 have the same shape (e.g., the second shape) as one another and the same shape as the second electrodes 511. The bases 520 of the triangles that form the second electrodes 512 are spatially aligned with each other (e.g., relative to the second axis 132) and are parallel to the first axis 131. The bases 520 of the triangles that form the second electrodes 512 are parallel to the bases 520 of the triangles that form the first electrodes 511. In addition, the bases 520 of the triangles that form the second electrodes 512 are located closer to the second side 532 of the second single-axis detector 214 than to the first side 531 of the second single-axis detector 214.

The first electrodes 511 are in the same orientation (e.g., a first orientation) as one another. The second electrodes 512 are in the same orientation (e.g., a second orientation) as one another but in a different orientation than the first electrodes 511. The orientation of the first electrodes 511 is the opposite of the orientation of the second electrodes 512. For example, the orientation of each first electrode 511 (e.g., triangle) in the first electrode set 501 is offset by 180 degrees relative to the orientation of each second electrode 512 (e.g., triangle) in the second electrode set 502. Offsetting the orientation of the first and second electrodes 511, 512 by 180 degrees creates complementary shapes/orientations that allow the first and second electrodes 511, 512 to be nested and/or interleaved with each other to maximize signal-detection area.

The triangles forming the first and second electrodes 511, 512 can have an elongated height 524 relative to a length 526 of the base 520 (i.e., the height 524 can be larger than the length 526). The height 524 can be measured from the base 520 to an apex 522 of the triangle along or relative to the second axis 132 and/or along or relative to the axis 5540. The length of the base 520 can be measured along or relative to the first axis 131. In one or more embodiments, the height 524 can be 20 to 200 times larger than the length 526 of the base 520.

The first electrodes 511 are electrically connected in parallel with each other and are not electrically connected to (e.g. electrically isolated from) the second electrodes 512. The second electrodes 512 are electrically connected in parallel with each other and are not electrically connected to (e.g. electrically isolated from) the first electrodes 511. A gap 530 is defined between and surrounds each first electrode 511 and each second electrode 511 so as to prevent electrical shorting between neighboring first electrodes 511, between neighboring second electrodes 512, and between neighboring first and second electrodes 511, 512. The first electrodes 511 and/or the second electrodes 512 can be different shapes and/or can have different orientations in other embodiments, such as complementary shapes that can be nested and/or interleaved with each other to maximize signal-detection area.

The first and second electrodes 511, 512 are interleaved and/or nested to cover the entire sensor plane 550, which is shown as square in FIG. 5. The sensor plane 550 can be another shape, such as rectangular, in other embodiments.

The first and second electrodes 511, 512 are configured and/or arranged such that the difference in the area of the first and second electrodes 511, 512 is linear or approximately linear relative (e.g., within about 5%) to and/or along the second axis 132. For example, the first electrodes 511 decrease in area linearly or approximately linearly relative to the second axis 132 in a first direction (e.g., from the base 520 to the apex 522 of each first electrode 511). The second electrodes 512 decrease in area linearly or approximately linearly relative to the second axis 132 in a second direction (e.g., from the base 520 to the apex 522 of each second electrode 512), opposite to the first direction.

An ionizing beam 360 passing through the second single-axis detector 214 in the perpendicular direction (e.g., parallel or substantially parallel to the third axis 133) will generate charge along its trajectory. This charge will be driven by the electric field to the second single-axis detector 214. The proportion of charge sensed by the second single-axis detector 214 is proportional to the intersection of the charge cloud and the first and second electrodes sets 501, 502. Since the relative areas of the first and second electrodes 511, 512 in the first and second electrodes sets 501, 502, respectively, is linear (or approximately linear) in position relative to the second axis 132, the ratio of the two charge values yields the position of the beam centroid relative to the second axis 132.

The second single-axis detector 214 can be optimized to reduce the capacitance of the detectors, which improves the signal-to-noise ratio, and therefore the accuracy of the measurement. For example, measurements of current in the nA to μA regime typically utilize the “transimpedance” amplifier topology. A source of current noise in such circuits is due to the input noise voltage of the amplifier driving current into the detector impedance. Since the impedance of the detector 214 is inversely proportional to the capacitance of the detector, every effort should be made to minimize the detector capacitance.

The first and second electrodes 511, 512 can comprise a thin-film, radiation-resistant substrate coated with one or more thin metal layers to form the electrodes 501, 502. To avoid the high capacitance arising from independent electrodes 511, 512 coupling through thin film, the electrode pattern can be duplicated on both sides of the substrate, and the matching pairs connected electrically using plated through holes and/or external connection means. This effectively creates a single electrode structure with minimal capacitance to surrounding electrodes. An example cross section through plane 60 can be the same as the cross section shown in FIG. 4.

The capacitance between the first and second electrodes 511, 512 is significant but can be reduced by increasing the un-plated kerf width (e.g., gaps 530) between the first and second electrodes 511, 512. This should be balanced against the impact on position accuracy. The larger the gaps 530, the greater reduction in capacitance between the first and second electrodes 511, 512 but the greater reduction/impact on position accuracy.

Additionally or alternatively, the capacitance between the first and second electrodes 511, 512 can be reduced by increasing the pitch of the pattern. This should be balanced against the impact on position accuracy due to poor sampling of the beam diameter.

In one or more embodiments, the first electrodes 511 can be referred to as third electrodes, the second electrodes 512 can be referred to as fourth electrodes.

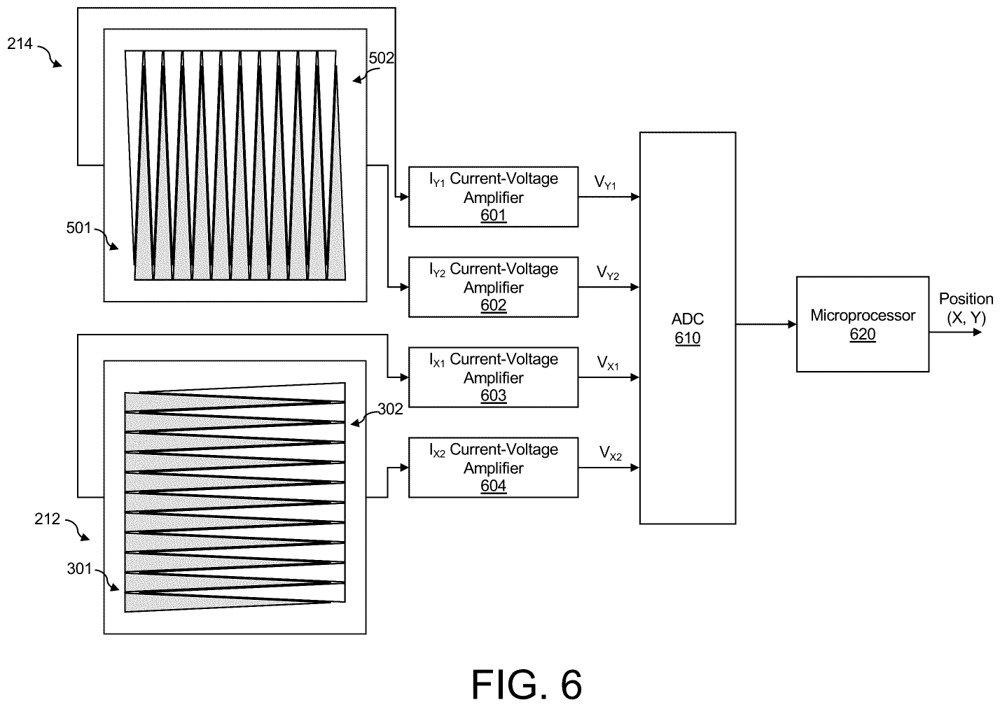

FIG. 6 is a block diagram of readout circuitry for the first and second single-axis detectors 212, 214 according to one or more embodiments.

The readout circuitry includes a four-channel electronic circuit capable of converting the four current signals output from each electrode set 301, 302, 501, 502 into analog voltages at the high speeds and low signal-levels expected in this application. For example, each channel can include a respective current-voltage amplifier 601-604 that can operate in the digital domain and can output a respective analog voltage.

The input of a first current-voltage amplifier 601 can be electrically coupled to the output of the electrode set 501. The output of the first current-voltage amplifier 601 is a first voltage V_{Y1} that corresponds to the current Iyi from the electrode set 501. The input of a second current-voltage amplifier 602 can be electrically coupled to the output of the electrode set 502. The output of the second current-voltage amplifier 602 is a second voltage V_{Y2} that corresponds to the current I_{Y2} from the electrode set 502. The input of a third current-voltage amplifier 603 can be electrically coupled to the output of the electrode set 301. The output of the third current-voltage amplifier 603 is a third voltage V_{X1} that corresponds to the current I_{X1} from the electrode set 301. The input of a fourth current-voltage amplifier 602 can be electrically coupled to the output of the electrode set 302. The output of the fourth current-voltage amplifier 604 is a fourth voltage V_{X2} that corresponds to the current I_{X2} from the electrode set 302.

The output of each current-voltage amplifier 601-604 is electrically coupled to the input of an analog-to-digital converter (ADC) 610 (or another digitization circuit) that converts the analog voltages into respective digital voltage values. The output of the ADC 610 is electrically coupled to the input of a microprocessor 620 that receives the four digital voltage signals and calculates the X and Y centroid positions (e.g., relative to the first and second axes 131, 132) using the four digital voltage signals and appropriate calibration and linearization procedures. The microprocessor 620 can be the same as the controller 130 (FIG. 1). The output of the microprocessor 620 is the X and Y (e.g., first and second) centroid position (e.g., relative to the first and second axes 131, 132).

In one or more embodiments, one, some, or all of the current-voltage amplifiers 601-604 can be replaced with respective transimpedance amplifier(s). In one or more embodiments, the amplifiers (e.g., current-voltage amplifiers and/or transimpedance amplifiers) and the ADC 610 (or another digitization circuit) may be combined into a signal electronic component.

The output of the microprocessor 620 can be provided to and/or used by the controller 130 (FIG. 1) as feedback to direct the ionized radiation beam 101 towards a target location, for example by adjusting the scan deflector electromagnets 122, for example in a feedback loop.

It is noted that the maximum stable bandwidth of the current-voltage amplifiers 601-604 and/or of the transimpedance amplifier(s) is limited by the capacitance of the first and second single-axis detectors 212, 214 and the gain bandwidth of the current-voltage amplifiers 601-604 and/or of the transimpedance amplifier(s). In addition to reducing the capacitance of the detector, the electronics can utilize high gate bandwidth (GBW) amplifiers that are also compatible with the low-current measurement requirements of this application.

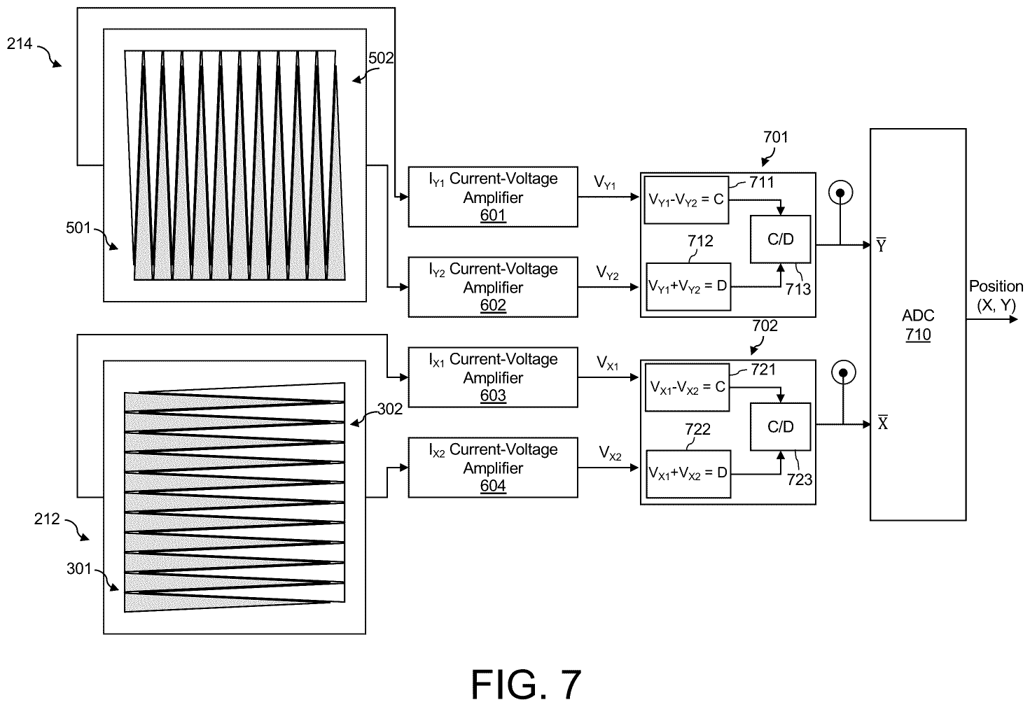

FIG. 7 is a block diagram of readout circuitry for the first and second single-axis detectors 212, 214 according to one or more alternative embodiments.

A first analog circuit 701 has inputs electrically coupled to the respective outputs of the first and second current-voltage amplifiers 601, 602 to receive the respective first and second voltages V_{Y1}, V_{Y2}. The first analog circuit 701 includes a first subcircuit 711 that is configured to calculate the difference between the first and second voltages V_{Y1}, V_{Y2} and a second subcircuit 712 that is configured to calculate the sum of the first and second voltages V_{Y1}, V_{Y2}. The outputs of the first and second subcircuits 711, 712 are electrically coupled to the input of a third subcircuit 713 that is configured to calculate the ratio of the outputs of the first and second subcircuits 711, 712 (i.e., the ratio of the difference between the first and second voltages V_{Y1}, V_{Y2} with respect to the sum of the first and second voltages V_{Y1}, V_{Y2}). This ratio represents and/or corresponds to a first position (e.g., the Y position) relative to the second axis 132. The output of the third subcircuit 713 is electrically coupled to a first input of an ADC 710.

A second analog circuit 702 has inputs electrically coupled to the respective outputs of the third and fourth current-voltage amplifiers 603, 604 to receive the respective third and fourth voltages V_{X1}, V_{X2}. The second analog circuit 702 includes a first subcircuit 721 that is configured to calculate the difference between the third and fourth voltages V_{X1}, V_{X2} and a second subcircuit 722 that is configured to calculate the sum of the third and fourth voltages V_{X1}, V_{X2}. The outputs of the first and second subcircuits 721, 722 are electrically coupled to the input of a third subcircuit 723 that is configured to calculate the ratio of the outputs of the first and second subcircuits 721, 722 (i.e., the ratio of the difference between the third and fourth voltages V_{X1}, V_{X2} with respect to the sum of the third and fourth voltages V_{X1}, V_{X2}). This ratio represents and/or corresponds to a second position (e.g., the X position) relative to the first axis 131. The output of the third subcircuit 723 is electrically coupled to a second input of the ADC 710. The first and second analog circuits 701, 702 can be identical except for their inputs and outputs.

The output of the ADC 710 (or another digitization circuit) converts the analog voltages into respective digital voltage values. The output of the ADC 710 is electrically coupled to the input of a microprocessor that receives the two digital voltage values and calculates the X and Y centroid positions (e.g., relative to the first and second axes 131, 132) using the two digital voltage values and appropriate calibration and linearization procedures. The microprocessor 720 can be the same as the controller 130 (FIG. 1). The output of the microprocessor is the X and Y (e.g., first and second) centroid position (e.g., relative to the first and second axes 131, 132).

In one or more embodiments, one, some, or all of the current-voltage amplifiers 601-604 can be replaced with respective transimpedance amplifier(s). In one or more embodiments, the amplifiers (e.g., current-voltage amplifiers and/or transimpedance amplifiers) and the ADC 710 (or another digitization circuit), and/or the analog circuits 701, 702 may be combined into a signal electronic component.

The output of the microprocessor 620 can be provided to and/or used by the controller 130 (FIG. 1) as feedback to direct the ionized radiation beam 101 towards a target location, for example by adjusting the scan deflector electromagnets 122, for example in a feedback loop.

It is noted that the maximum stable bandwidth of the current-voltage amplifiers 601-604 and/or of the transimpedance amplifier(s) is limited by the capacitance of the first and second single-axis detectors 212, 214 and the gain bandwidth of the current-voltage amplifiers 601-604 and/or of the transimpedance amplifier(s). In addition to reducing the capacitance of the detector, the electronics can utilize high gate bandwidth (GBW) amplifiers that are also compatible with the low-current measurement requirements of this application.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Sets or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A position detector for a charged particle beam, comprising:
a first high-voltage plane;
a first single-axis detector disposed in a first detector plane comprising:
a first electrode having a set of first electrode elements, each first electrode element having a first shape in a first orientation, the first electrode elements spatially distributed with respect to a first axis, the first electrode elements electrically connected to one another; and
a second electrode having a set of second electrode elements, each second electrode element having the first shape in a second orientation that is different than the first orientation, the second electrode elements spatially distributed with respect to the first axis and interleaved with the first electrode elements, the second electrode elements electrically connected to one another;
a second high-voltage plane, the first single-axis detector disposed between the first and second high-voltage planes;
a second single-axis detector in a second detector plane comprising:
a third electrode having a set of third electrode elements, each third electrode element having a second shape in a third orientation, the third electrode elements spatially distributed with respect to a second axis, the third electrode elements electrically connected to one another; and
a fourth electrode having a set of fourth electrode elements, each fourth electrode element having the second shape in a fourth orientation that is different than the third orientation, the fourth electrode elements spatially distributed with respect to the second axis and interleaved with the third electrode elements, the fourth electrodes electrically connected to one another; and
a third high-voltage plane, the second single-axis detector disposed between the second and third high-voltage planes,
wherein the first detector plane, the second detector plane, the first high-voltage plane, the second high-voltage plane, and the third high-voltage plane are substantially parallel to one another.

2. The position detector of claim 1, wherein the first shape is a triangle.

3. The position detector of claim 2, wherein:
in the set of first electrode elements, a respective base of each triangle is closer to a first side of the position detector than to a second side of the position detector, and
in the set of second electrode elements, the respective base of each triangle is closer to the second side of the first single-axis detector than to the first side of the first single-axis detector, the first and second sides on opposing sides of the position detector relative to the first axis.

4. The position detector of claim 3, wherein:
the respective bases of the triangles in the set of first electrode elements are parallel to the second axis and aligned with respect to each other relative to the first axis, and
the respective bases of the triangles in the set of second electrode elements are parallel to the second axis and aligned with respect to each other relative to the first axis.

5. The position detector of claim 4, wherein a respective height of each triangle, as measured between the respective base of a respective triangle and a respective apex of the respective triangle relative to the first axis, is larger than a respective length of the respective base of the respective triangle, as measured relative to the second axis.

6. The position detector of claim 4, wherein the respective height is 20 times to 200 times larger than the length of the respective base.

7. The position detector of claim 3, wherein:
the triangle is a first triangle,
the second shape is a second triangle;
in the set of third electrode elements, a respective base of each second triangle is closer to a third side of the position detector than to a fourth side of the position detector, and
in the set of fourth electrode elements, the respective base of each second triangle is closer to the fourth side of the position detector than to the third side of the position detector, the third and fourth sides on opposing sides of the position detector relative to the second axis.

8. The position detector of claim 7, wherein:
the respective bases of the second triangles in the set of third electrode elements are parallel to the first axis and aligned with respect to each other relative to the second axis, and
the respective bases of the second triangles in the set of fourth electrode elements are parallel to the first axis and aligned with respect to each other relative to the second axis.

9. The position detector of claim 8, wherein a respective height of each second triangle, as measured between the respective base of a respective second triangle and a respective apex of the respective second triangle relative to the second axis, is larger than a respective length of the respective base of the respective second triangle, as measured relative to the first axis.

10. The position detector of claim 9, wherein:
a respective height of each first triangle is the same as the respective height of each second triangle,
a respective length of the respective base of a respective first triangle is the same as the respective length of the respective base of the respective second triangle,
the respective height of each first triangle is measured between the respective base of the respective first triangle and a respective apex of the respective first triangle relative to the first axis, and
the respective length of the respective base of the respective first triangle is measured relative to the second axis.

11. The position detector of claim 7, wherein:
the first single-axis detector comprises:
a first substrate;
a plurality of first metal patterned metal segments disposed on a first side of the first substrate;
a plurality of second metal patterned metal segments disposed on a second side of the first substrate; and
a plurality of first conductive vias defined in the first substrate, each first conductive via electrically connecting a respective first metal patterned metal segment and a respective second patterned metal segment, the respective first metal patterned metal segment and the respective second metal patterned metal segment having the first shape; and
the second single-axis detector comprises:
a second substrate;
a plurality of third metal patterned metal segments disposed on a first side of the second substrate;
a plurality of fourth metal patterned metal segments disposed on a second side of the second substrate; and
a plurality of second conductive vias defined in the second substrate, each second conductive via electrically connecting a respective third metal patterned metal segment and a respective fourth patterned metal segment, the respective third metal patterned metal segment and the respective fourth metal patterned metal segment having the second shape.

12. The position detector of claim 1, wherein:
the first and second shapes are a triangle,
an area of the first electrode elements decreases linearly in a first direction relative to the second axis,
an area of the second electrode elements decreases linearly in a second direction relative to the second axis, the second direction opposite to the first direction,
an area of the third electrode elements decreases linearly in a third direction relative to the first axis, and
an area of the fourth electrode elements decreases linearly in a fourth direction relative to the first axis, the fourth direction opposite to the third direction.

13. The position detector of claim 1, wherein:
a difference in the areas of the first and second electrode elements is linear relative to the second axis,
a difference in the areas of the third and fourth electrode elements is linear relative to the first axis.

14. A position detector system for a charged particle beam, comprising:
a first high-voltage plane;
a first single-axis detector disposed in a first detector plane comprising:
a set of first electrodes, each first electrode having a first shape in a first orientation, the first electrodes spatially distributed with respect to a first axis, the first electrodes electrically connected to one another; and
a set of second electrodes, each second electrode having the first shape in a second orientation that is different than the first orientation, the second electrodes spatially distributed with respect to the first axis and interleaved with the first electrodes, the second electrodes electrically connected to one another;
a second high-voltage plane, the first single-axis detector disposed between the first and second high-voltage planes;
a second single-axis detector in a second detector plane comprising:
a set of third electrodes, each third electrode having a second shape in a third orientation, the third electrodes spatially distributed with respect to a second axis, the third electrodes electrically connected to one another; and
a set of fourth electrodes, each fourth electrode having the second shape in a fourth orientation that is different than the third orientation, the fourth electrodes spatially distributed with respect to the second axis and interleaved with the third electrodes, the fourth electrodes electrically connected to one another; and
a third high-voltage plane, the second single-axis detector disposed between the second and third high-voltage planes;
a readout circuit comprising:
a first current-voltage amplifier having an input electrically coupled to an output of the set of first electrodes;
a second current-voltage amplifier having an input electrically coupled to an output of the set of second electrodes;
a third current-voltage amplifier having an input electrically coupled to an output of the set of third electrodes;
a fourth current-voltage amplifier having an input electrically coupled to an output of the set of fourth electrodes; and
an analog-to-digital converter (ADC) having a respective input electrically coupled to a respective output of each current-voltage amplifier; and
a microprocessor having an input electrically coupled to an output of the ADC.

15. The position detector of claim 14, wherein:
the first and second shapes are a triangle,
an area of the first electrodes decreases linearly in a first direction relative to the second axis;
an area of the second electrodes decreases linearly in a second direction relative to the second axis, the second direction opposite to the first direction;
an area of the third electrodes decreases linearly in a third direction relative to the first axis;
an area of the fourth electrodes decreases linearly in a fourth direction relative to the first axis, the fourth direction opposite to the third direction.

16. The position detector of claim 15, wherein:
a difference in the areas of the first and second electrodes is linear relative to the second axis,
a difference in the areas of the third and fourth electrodes is linear relative to the first axis.

17. The position detector system of claim 16, wherein:
the first current-voltage amplifier outputs a first voltage corresponding to a first current from the set of first electrodes,
the second current-voltage amplifier outputs a second voltage corresponding to a second current from the set of second electrodes,
the third current-voltage amplifier outputs a third voltage corresponding to a third current from the set of third electrodes,
the fourth current-voltage amplifier outputs a third voltage corresponding to a third current from the set of third electrodes,
the ADC converts the first, second, third, and fourth voltages into first, second, third, and fourth digital voltage values, respectively, and
the microprocessor is configured to determine a first position of the charged particle beam relative to the first axis using the first and second digital voltage values and to determine a second position of the charged particle beam relative to the second axis using the third and fourth digital voltage values.

18. A position detector system for a charged particle beam, comprising:
a first high-voltage plane;
a first single-axis detector disposed in a first detector plane comprising:
a set of first electrodes, each first electrode having a first shape in a first orientation, the first electrodes spatially distributed with respect to a first axis, the first electrodes electrically connected in parallel; and
a set of second electrodes, each second electrode having the first shape in a second orientation that is different than the first orientation, the second electrodes spatially distributed with respect to the first axis and interleaved with the first electrodes,
the second electrodes electrically connected in parallel;
a second high-voltage plane, the first single-axis detector disposed between the first and second high-voltage planes;
a second single-axis detector in a second detector plane comprising:
a set of third electrodes, each third electrode having a second shape in a third orientation, the third electrodes spatially distributed with respect to a second axis, the third electrodes electrically connected in parallel; and
a set of fourth electrodes, each fourth electrode having the second shape in a fourth orientation that is different than the third orientation, the fourth electrodes spatially distributed with respect to the second axis and interleaved with the third electrodes, the fourth electrodes electrically connected in parallel; and
a third high-voltage plane, the second single-axis detector disposed between the second and third high-voltage planes; and
a readout circuit comprising:
a first current-voltage amplifier having an input electrically coupled to an output of the set of first electrodes, the first current-voltage amplifier producing, at a first output, a first voltage corresponding to a first current from the set of first electrodes;
a second current-voltage amplifier having an input electrically coupled to an output of the set of second electrodes, the second current-voltage amplifier producing, at a second output, a second voltage corresponding to a second current from the set of second electrodes;
a third current-voltage amplifier having an input electrically coupled to an output of the set of third electrodes, the third current-voltage amplifier producing, at a third output, a third voltage corresponding to a third current from the set of third electrodes;
a fourth current-voltage amplifier having an input electrically coupled to an output of the set of fourth electrodes, the fourth current-voltage amplifier producing, at a fourth output, a fourth voltage corresponding to a fourth current from the set of fourth electrodes;
a first analog circuit having a first input electrically coupled to the first output of the first current-voltage amplifier and a second input electrically coupled to the second output of the second current-voltage amplifier, the first analog circuit configured to produce a fifth voltage corresponding to a ratio of a difference of the first and second voltages with respect to a sum of the first and second voltages;
a second analog circuit having a third input electrically coupled to the third output of the third current-voltage amplifier and a fourth input electrically coupled to the fourth output of the fourth current-voltage amplifier, the second analog circuit configured to produce a sixth voltage corresponding to a ratio of a difference of the third and fourth voltages with respect to a sum of the third and fourth voltages;
an analog-to-digital converter (ADC) having a first input electrically coupled to a first output of the first analog circuit and a second input electrically coupled to a second output of the second analog circuit, the ADC configured to convert the fifth and sixth voltages into fifth and sixth digital voltage values, respectively; and
a microprocessor having an input electrically coupled to an output of the ADC, the microprocessor configured to determine a first position of the charged particle beam relative to the first axis using the fifth digital voltage value and to determine a second position of the charged particle beam relative to the second axis using the sixth digital voltage value.

19. The position detector of claim 18, wherein:
the first and second shapes are a triangle,
an area of the first electrodes decreases linearly in a first direction relative to the second axis;
an area of the second electrodes decreases linearly in a second direction relative to the second axis, the second direction opposite to the first direction;
an area of the third electrodes decreases linearly in a third direction relative to the first axis;
an area of the fourth electrodes decreases linearly in a fourth direction relative to the first axis, the fourth direction opposite to the third direction.

20. The position detector of claim 19, wherein:
a difference in the areas of the first and second electrodes is linear relative to the second axis,
a difference in the areas of the third and fourth electrodes is linear relative to the first axis.
